(19) United States
(12) Patent Application Publication
(10) Pub. No.: US 2007/0260582 A1
(43) Pub. Date: Nov. 8, 2007

(54) Method and System for Visual Query Construction and Representation

(75) Inventor: Guanghong Larry Liang, Piscataway, NJ (US)

Correspondence Address: SYNNESTVEDT LECHNER & WOODBRIDGE LLP, P O BOX 592, 112 NASSAU STREET, PRINCETON, NJ, 08542-0592, US

(73) Assignee: INETSOFT TECHNOLOGY, Piscataway, NJ (US)

(21) Appl. No.: 11/745,007

(22) Filed: May 7, 2007

Related U.S. Application Data
(60) Provisional application No. 60/746,501, filed on May 5, 2006.

(51) Int. Cl. G06F 17/30

(52) U.S. Cl. 707/2

(57) ABSTRACT

A method and system for visually constructing and displaying relational queries on a tabular interface. A query is a relational expression that defines how to extract and process data from a data source. A data source could be a relational database, or other sources where data can be extracted and converted to tables consisting of column. A query may be composed from other queries using relational operators such as join and union, potentially resulting in a complex intertwined tree-like structure. The invention provides methods of representing hierarchical query structure on a tabular interface using nested table structures, and steps for constructing and manipulating the structure using spatial relationships. Unique to this method is the ability to work with highly complex hierarchical tree-link structure using a simple two-dimensional table. Also unique to this method is the ability to change the hierarchical structure using relative spatial placement of the tables.

### CROSS-REFERENCE TO RELATED APPLICATIONS

This application is based on and claims priority to U.S. Provisional Application No. 60/746,501, filed May 5, 2006, the contents of which are fully incorporated herein by reference.

### BACKGROUND OF THE INVENTION

### Field of the Invention

The present invention relates to computer methods and systems for designing and manipulating queries, and more specifically, to methods and systems for creating relational queries using a graphic user interface.

A relational database is the most widely used technology for storing structured information, such as order transactions, catalogs, and customer histories. All modern relational databases are based on the relational algebra invented in the 1970's. SQL (Structured Query Language) is the standard querying language for accessing and manipulating data in the databases. SQL provides a declarative syntax by which a person may craft a query to select data records and perform other processing such as grouping, filtering, and aggregation.

Relational queries are based on the concept of relational algebra. A relational database consists of a number of relations (tables). Each table consists of tuples (rows) with identical attributes (columns). The process of constructing a query is to formulate a relational expression to extract data from the tables. In the simplest form, a query may simply select a subset of rows and columns from a single table. More often it is necessary to combine (join) more than one table to get a meaningful result.

FIG. 1 shows an example of a database containing order transaction information. There are five tables in the database, with Orders and Order_details capturing order data, and other tables providing reference information (customer information, product information, and product category information in this example). To get a list of product each customer purchased, a query is constructed to join the data from the Customer table with Orders, Order_details, and Products. A join is created by combining two or more tables by defining relationships between the tables in the form of conditions between columns sharing same values. For example, a join of Order_details and Products can be created by using the product ID as the joining condition:

Order_details.product_id=Products.product_id.

Relational queries also allow tables to be used as sets, and perform set operations on the results. For example, the union of query A and B consists of all the rows in either A or B. The intersection of query A and B consists of all the rows in both A and B.

As a language intended to be used by highly trained computer professionals, SQL is very powerful but difficult to learn. The difficulty results from the need to understand relational algebra that defines the meaning of the queries, as well as the precise syntax of the SQL language. It is generally agreed that a query interface based on point-and-click graphic operations is needed to serve the non-technical community.

There have been various attempts to simplify the process of creating queries. A commonly employed solution is to add a high-level abstraction layer, the so-called business layer. The business layer comprises a set of objects (entities) and attributes in each object that maps to the physical database. It also contains information about the relationships between the physical tables in the database. When a user selects a set of attributes to be included in the output, a query generation engine is used to dynamically generate the SQL queries to retrieve the information based on the prior definition in the business layer.

The idea of the business layer is to shield users from the complexity of the SQL language, while making the data and functionality of the database accessible to users without knowledge of the inner working of the database. This works reasonably well for simple selections and filtering of data. But the simplicity of this model prevents the users from creating queries that go beyond simple selection and filtering, such as queries that are composed of other sub-queries and/or having multiple levels of nesting. Another drawback of the business layer based approach is that all relationships between data must be defined beforehand. End users have no control of how the tables are joined when using the business layer.

Other attempts include Query By Example (QBE), where a user creates a query by typing values in a form containing fields in the database, and the values are used to generate filtering conditions in the final query. It is useful in the simple case where only simple filtering is required, but falls short when the requirement exceeds simple selection.

To understand some of the benefits of the present invention, it is helpful to understand the operation of the prior art. Using the business layer approach, the data relationships can be specified in the metadata layer as shown in FIG. 1. A user can create a simple query to show all customers who have purchased a computer by selecting the output columns, and specifying a condition to only include records with category matching ‘computer. The resulting SQL would be similar to the following:

```
select company from customer, product, category, orders, order_details
  where customer.customer_id = orders.customer_id and
      orders.orderno = order_details.orderno and
    order_details.product_id = product.product_id and
    product.category_id = category.category_id and
      category.category = ‘computer’
```

But if the question is changed to show customers who have purchased both computers and cell phones, the user can't simply add another condition to limit the records to match both computer and cell phone. If the condition is changed to: category.category=‘computer’ and category.category=‘cell phone’, the query would return no record, as is apparent from the sample data in FIG. 2, because there is no row that contains a category of both computer and cell phone. In other words, due to the way relational databases store data, there will be a first row identifying the fact that a customer purchased a computer, and a second row indicating the fact that a customer purchased a cell phone, but there will not be a single row identifying a customer as having purchased both.

In order to receive results showing customers who have purchased both computers and cell phones, two queries are required. The first query retrieves all records matching computer, and the second query retrieves all records matching cell phone. The results are then intersected (as a set operation) to get customers that purchased both products. The SQL for this is the following:

```
select company from customer, product, category, orders, order_details
  where customer.customer_id = orders.customer_id and
      orders.orderno = order_details.orderno and
    order_details.product_id = product.product_id and
    product.category_id = category.category_id and
      category.category = ‘computer’
intersect
select company from customer, product, category, orders, order_details
  where customer.customer_id = orders.customer_id and
      orders.orderno = order_details.orderno and
    order_details.product_id = product.product_id and
    product.category_id = category.category_id and
      category.category = ‘cell phone’
```

A multiple query intersection for performing the operations described in SQL above could be depicted visually as shown generically in FIG. 3.

To effectively solve the problem of dealing with the complexities of SQL, it is important to provide a mechanism with the proper balance of ease of use, and at the same time with enough flexibility to meet everyday requirements. The difficulty in creating a query results from the following issues. The query designer must abstract the hierarchical query structure and translate that into flat text. Using prior art methods, the relationships between different parts of the query are not clearly exposed and are difficult to visualize and modify. Additionally, it is difficult to verify the correctness of the query without examining the sub-components of the query and their results.

### SUMMARY OF THE INVENTION

An embodiment of the present invention provides a method and system for visually displaying and manipulating relational queries in a tabular format. A simple query is represented by a two dimensional table (referred to herein as a “sub-table” or “single table”) consisting of a set of rows and columns, with each column corresponding to a column from the underlying data source. A composite query is a combination of two or more simple queries. A composite query is displayed as a two-dimensional table (referred to herein as a “composite table” or “nested table”) composed of two or more sub-tables. The relationships of the sub-tables in the composite table are displayed as connector lines below or next to the tables.

Each query is displayed as a single or nested table, with the nesting structure corresponding to the hierarchical structure of relational queries. The invention also relates to the steps for interacting with the nested table structure for creating relational queries. Complex queries can be displayed and manipulated in the same form as they are visually displayed, as two-dimensional tables. Relationships between queries are encoded and visualized directly in the table, and can be modified by directly manipulating the visual elements.

### BRIEF DESCRIPTION OF THE DRAWINGS

FIG. 1 is a relational diagram of the example database tables.

FIG. 2 is a table showing the sample data in the database.

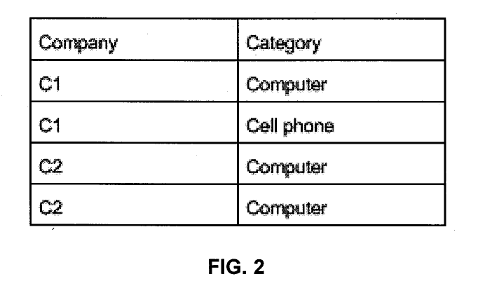

FIG. 3 is a visual depiction of the example query as a tree structure.

FIG. 4 shows an example of how a joined table can be displayed as nested tables.

FIG. 5 shows an example of how a concatenated table can be displayed as nested tables.

FIG. 6 is a flowchart and shows an example of how the method of the invention can be realized.

FIG. 7 shows an example of how a simple query can be displayed on a tabular interface.

FIGS. 8a-b show an example of how a concatenated table can be created.

FIGS. 9a-b show an example of how a joined table can be created.

FIGS. 10a-e show an example of creating an intersection of two queries to retrieve the customers who have purchased both computers and cell phones.

### DETAILED DESCRIPTION OF THE PREFERRED EMBODIMENTS

The present invention provides a method and system for interactively creating a relational query using spatial relationship of the data items. The visual encoding of the relationships simplifies the task by providing a method to directly manipulate the data in the form as they are intuitively understandable to average users. The method of the invention can be carried out by means of any general purpose computer having a processor unit for performing the steps of the method under the control of a computer program and a computer screen for displaying the data items.

The use of relational database terminology in this description is not an indication that the invention is restricted to relational databases. The method and system covered by the present invention can be applied to all data sources where data can be extracted as tabular tables. The resulting query produced by the described method could be translated into a query against a relation database, or processed by a computer program to produce the prescribed results.

The composition of a query from other queries may take many forms. The two main types of composition are concatenation and join. A concatenation of two queries performs a set operation on the data of the two queries. The operation can be a union, intersection, or a subtraction. A union of two queries is distinct list of rows that are in either sub-query. An intersection of two queries consists of the rows that are in both sub-queries. A subtraction of query A from query B consists of the rows that are in A but not in B.

A join of two queries creates a cross product of the rows in two tables. The sub-queries are normally joined with one or more join relationships. For example, when a Customer table is joined with Orders table, the two tables are related by the customer ID field. By using the customer ID as the join relation, the resulting table contains the information for each order and the customer who placed the order.

In accordance with the present invention, a user can compose new queries or change existing queries by dragging a table or a column, and placing it at a position that “signals” the type of relationship to be created for the tables. In other words, each relationship to be used in forming queries is predefined based on the positions of a table relative to another table. The tables are manipulatable around a work space, e.g., by dragging them to locations within a GUI (Graphical User Interface), and how they are placed relative to each other automatically determines a default relationship between the tables. The system receives a signal when an object is moved on the display device. The system compares the new position of the object with the position of other objects, and determines whether the action causes a new query to be created, or existing relationships to be altered. If it is determined that a query is to be created or an existing relationship is to be altered, the action is automatically performed. The relationships captured by the relative positioning of objects can include concatenation and join.

The relationships between sub-queries in a composite query are visually encoded by their relative position. A composite query created from the join of two tables is displayed as two tables side-by-side, with the join columns connected to show the join relationship. A composite query created from the concatenation of two tables, which could be the union, intersection, or subtraction of the two sub-queries, is displayed as two tables one above the other, with a vertical connector showing the type of relationship (e.g. union, intersection, or subtraction).

The relationships between sub-queries can be changed by positioning the tables to their visually encoded position. Moving a table immediately below another table creates a concatenation of the two tables. Moving a table immediately next to another table (side-by-side) creates a merging of the two tables. Join relationships can be created by dragging a column from one table and connecting it with another column in another table.

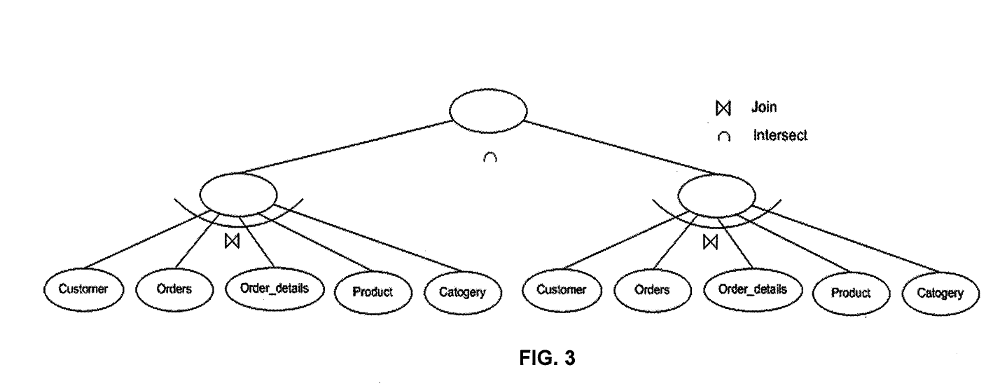

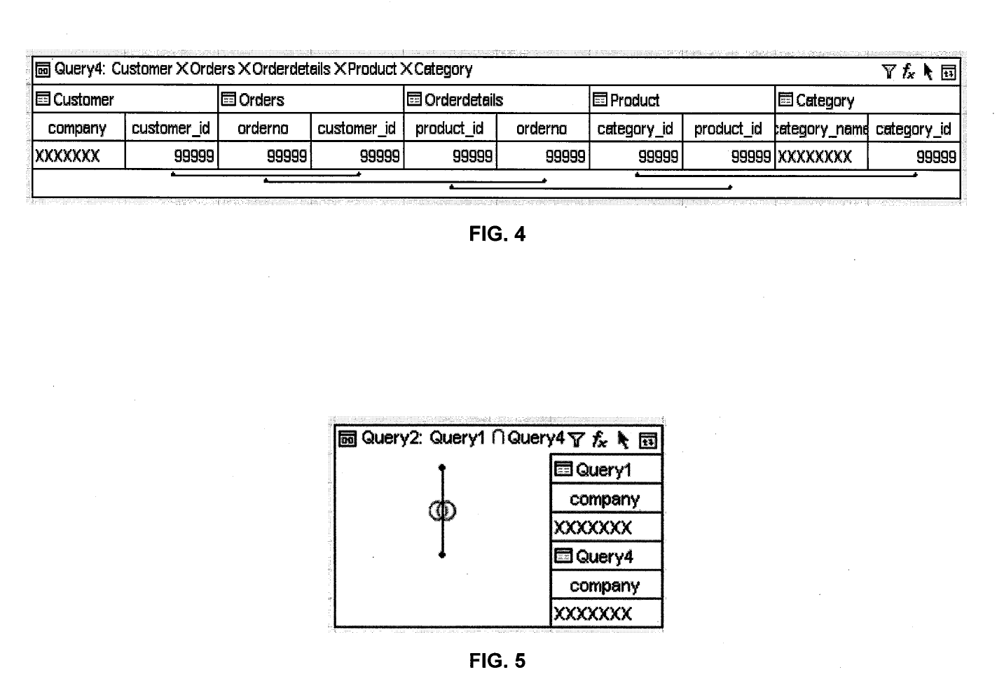

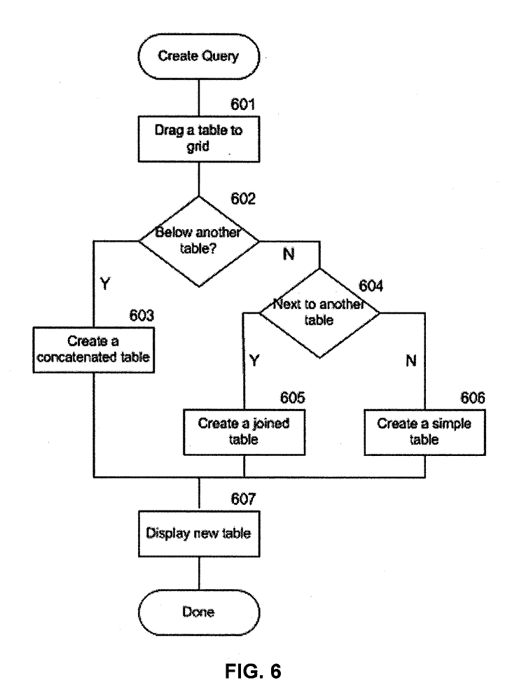

FIG. 4 illustrates how the join illustrated in the example of FIG. 3 can be created and displayed using the present invention, and FIG. 5 illustrates how the intersection of the two queries that selects computer and cell phone purchases can be displayed, again, using the present invention.

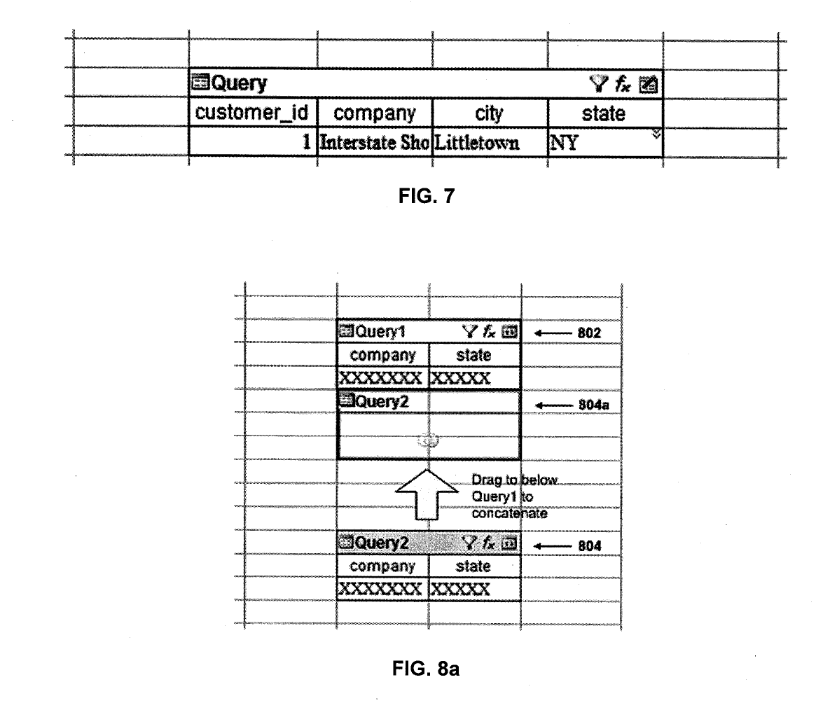

FIG. 6 shows a flow chart of the operation of an exemplary computer program for creating a new query according to the invention. When the program is started, it presents an interface for working with queries e.g., a GUI window displayed on a display device. The interface would preferably have a tabular grid to make it easy to align two dimensional data tables, but other display methods may be used and still fall within the scope of the present invention. A user creates a query by adding data tables from a set of pre-established data tables to the work surface. In the simplest case, a table may be created to map directly to a data source. Simple tables can be combined to create composite tables to either concatenate or join the tables into another result.

A user starts by dragging a table from the available data sources onto the interface, step 601. Available data sources could be from a physical database, a data model, or other data sources accessible by the system. The data sources could be displayed as a tree or list on or adjacent to the same interface. They could also be presented through other known mechanisms and still fall within the scope of this invention. Once a table is added to the interface, the system determines if it has been placed at a position that signals a relationship with another table, step 602. For example, if the system has been configured to signal a concatenation relationship between tables that are placed in vertical alignment with each other (e.g., one table placed immediately below another within a predetermined distance of each other), then if the new table is placed immediately below another table, a concatenated composite table is created, step 603. The concatenation can use a default relational concatenation operator such as union. The concatenation operator can be changed by the user after the concatenation is created, if desired.

If the system has been configured to signal a join relationship between tables that are placed in horizontal alignment with each other (e.g., one table placed directly next to another within a predetermined distance of each other), then if the new table is placed directly next to another table, step 604, a joined table is created by merging the two tables as shown in step 605. The particular join relationship used can be changed after the joined table is created. If the new table is placed at a location outside of the “signal parameters” defined for the system, i.e., at a location that is not adjacent to any other table vertically or horizontally, a standalone table is created, step 606. After a new table is created, it is displayed on the tabular interface and can be used for further manipulation or as the result of the query, step 607.

The same steps can be used to edit an existing query. Instead of dragging from an external list of tables to add to the query, tables that already exist can be dragged and placed at the same relative positions to change the relationships and structures of the query.

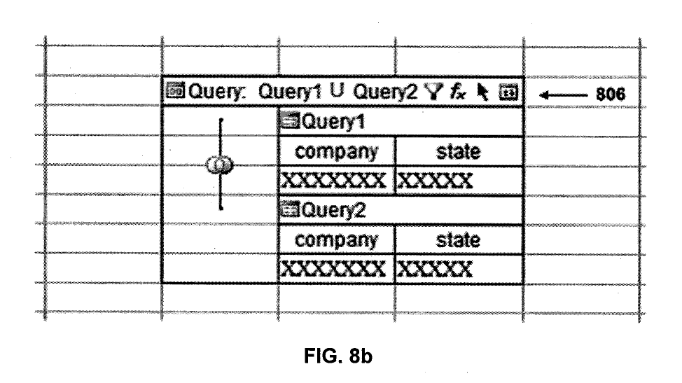

FIG. 7 shows an example of a simple query displayed as a two-dimensional table on a tabular interface, in accordance with the present invention. A simple query is a direct mapping to a data item in a data source. In the case of relational database, a simple query may consist of columns from a single physical table. Or in the presence of data model, the set of columns could correspond to attributes of logical entities. A simple query may contain filtering, sorting, and other known simple processing methods that can be performed on a table.

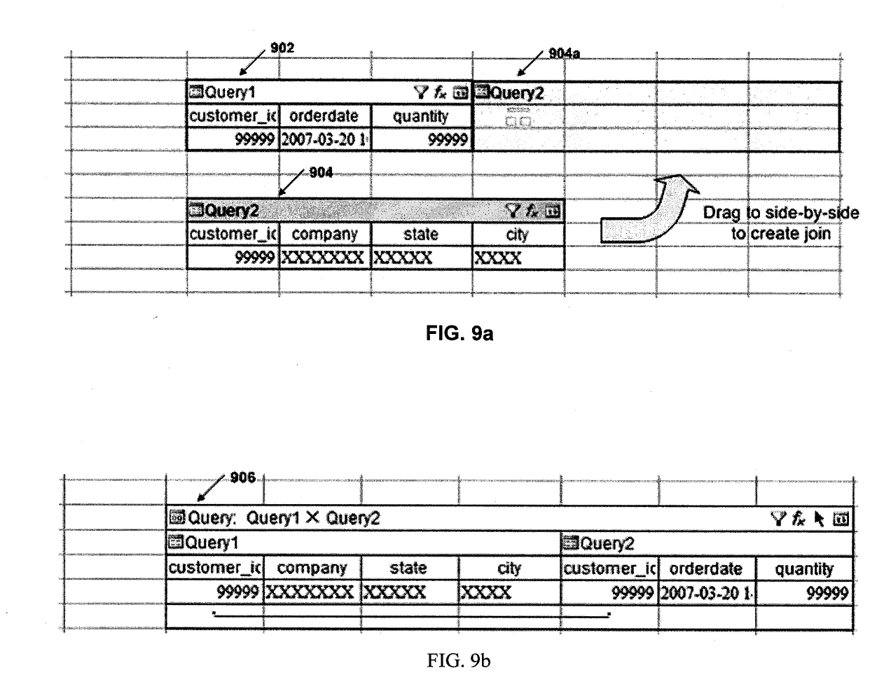

FIGS. 8a-b illustrate the creation of a concatenated table in accordance with the example of the present invention described in FIG. 6. Two separated tables 802 and 804, with compatible columns as defined by SQL, can be concatenated into a composite table. First, the two tables are moved such that one table is placed immediately below another table. This movement is illustrated in FIG. 8a by the shaded version of the “Query 2” table (804a) being positioned directly beneath table 802. The computer program embodying the present invention detects the relative positions of the two tables, and following the logic depicted in FIG. 6, it determines the spatial placement of the new table signals a concatenation operation. A new concatenated table 806 is created as shown in FIG. 8b.

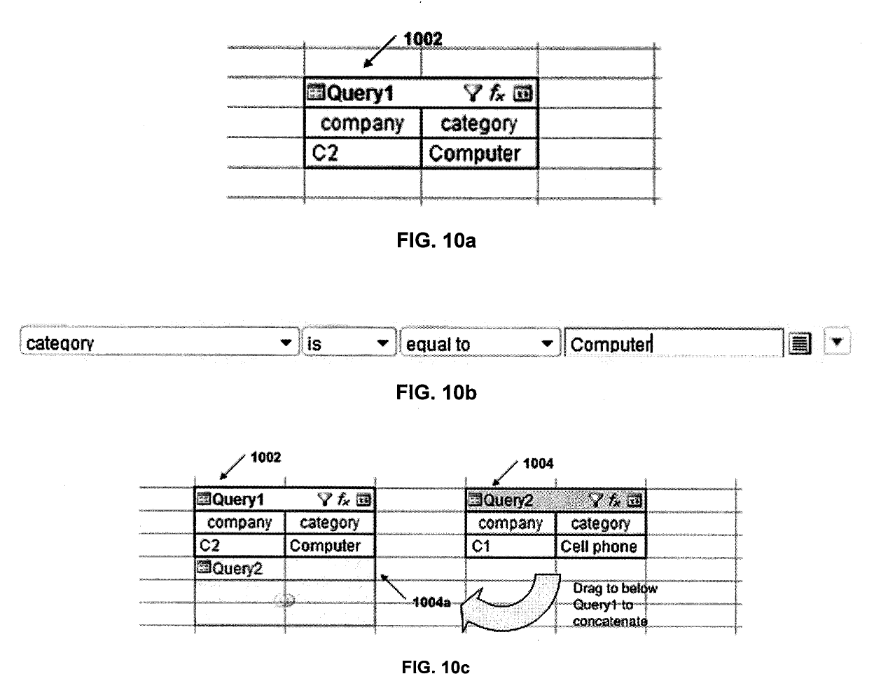

FIGS. 9a-b illustrate the creation of a joined table in accordance with the example of the present invention described in FIG. 6. Tables 902 and 904 can be joined by moving table 904 so that it is situated side-by-side with table 902, directly against each other, as illustrated by the shaded version of the “Query 2” table (904a). The computer program embodying the present invention detects the relative positions of the two tables. Following the logic depicted in FIG. 6, it determines that the spatial placement of the new table signals a join operation. A new joined table 906 is created as illustrated in FIG. 9b. The newly created joined table 906 may contain a join relationship defined on the meta-data layer, or relationships specified explicitly by the user.

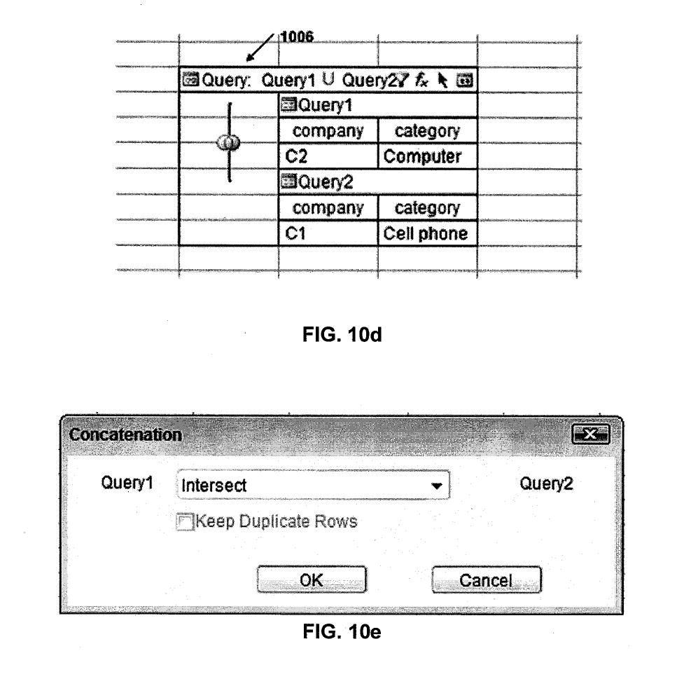

FIGS. 10a-d show an example of the creation of a query to find the customers who have purchased both computers and cell phones, using the method of the present invention. The objective of this example is to create a composite query (Query 3) which is an intersection of a first query that returns a listing of customers who purchased computers (Query 1) and a second query that returns a listing of customers who purchased cell phones (Query 2). For this example it is assumed that the necessary database tables are made available as data sources either as physical tables or a relational data model. First, a table for Query 1 (1002) is created with Company and Category by dragging the data items from the data source to the workspace, to create table 1002 as shown in FIG. 10a. A fully-constructed table could be dragged directly from the data source, e.g., a tree or list, to the workspace to place table 1002, including all columns shown, on the workspace. Alternatively, the individual columns making up table 1002 can be dragged to the workspace and added to the table (created when the first column is dragged) one by one.

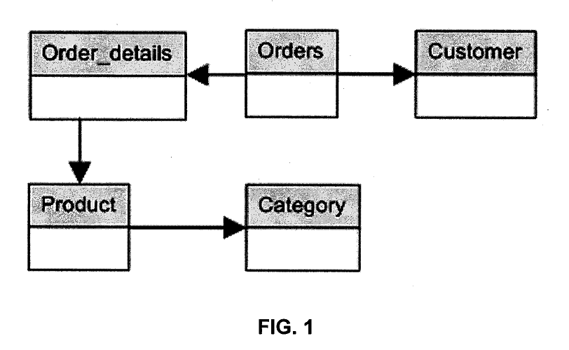

Next a condition is selected to include in the table only data pertaining to customers that have purchased a computer, using, for example, a drop-down menu as illustrated in FIG. 10b. Note that for the table 1002 in FIG. 10a, this step has already been performed. Following the same steps, a Query 2 table 1004 (not shown in FIG. 1) is created that includes data pertaining only to customers that have purchased a cell phone.

After both tables 1002 and 1004 are prepared, table 1004 is moved from its location in the workspace (to the right of table 1002 as shown in FIG. 10c) to a position directly below table 1002, as shown by shaded table 1004a in FIG. 10c, creating a concatenated table 1006 as shown in FIG. 10d. The concatenated table 1006 may use a default set operator such as union. To change the concatenation to be the intersection of the two sub-queries (instead of the default union value), a user can select a different operator using a drop-down menu, illustrated in FIG. 10e (showing the union operator changed to an intersect operator).

It is understood that there are numerous modifications that can be made to the preferred embodiment described herein and still fall within the scope of the claimed invention. For example, while in the preferred embodiment the “signals” regarding the positioning of one table relative to another are based on the two tables being vertically or horizontally positioned next to each other (e.g., so their borders are “touching”), the system could instead be configured to signal the tables as being in a position to establish a “composite relationship” when the two tables are placed within a predetermined distance of one another. Such a modification is considered to be covered by the appended claims.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

I claim:

1. A method of constructing composite queries using two-dimensional sub-tables displayed in a workspace of a graphical user interface, where each sub-table represents a simple query against a predefined data source, comprising:
defining a plurality of algebraic relationships between data in a first sub-table displayed in said workspace and data in a second sub-table displayed on said workspace based on a spatial placement of said first sub-table relative to said second sub-table;
identifying the spatial placement of said first sub-table and said second sub-table in said workspace; and
creating a composite table comprising said first sub-table and said second sub-table when the spatial placement of said first sub-table relative to said second corresponds to one of said defined plurality of algebraic relationships.

2. The method of claim 1, wherein said sub-tables are manipulatable within said workspace by a user, so that the user changes the spatial placement of said first and/or second sub-tables to create a desired composite table.

3. The method of claim 1 wherein a composite query comprising simple sub-queries with set operations is displayed as a nested table arranged within the created composite table.

4. The method of claim 1 wherein a composite query comprising simple sub-queries with join operations is displayed as a nested table arranged within the composite table.

5. The method of claim 1 wherein a placement of said second sub-table immediately below said first sub-table generates said composite table as a concatenated table with said first and second sub-tables connected by a default set operator.

6. The method of claim 1 wherein a placement of a said second sub-table immediately next to said first sub-table generates said composite table as a joined table.

7. The method of claim 1 wherein the relationship of said first and second sub-tables within said composite table may be modified by changing properties of table connectors connecting said first and second sub-tables.

8. A system of constructing composite queries using two-dimensional sub-tables displayed in a workspace of a graphical user interface, where each sub-table represents a simple query against a predefined data source, comprising:
means for defining a plurality of algebraic relationships between data in a first sub-table displayed in said workspace and data in a second sub-table displayed on said workspace based on a spatial placement of said first sub-table relative to said second sub-table;
means for identifying the spatial placement of said first sub-table and said second sub-table in said workspace; and
means for creating a composite table comprising said first sub-table and said second sub-table when the spatial placement of said first sub-table relative to said second corresponds to one of said defined plurality of algebraic relationships.

9. The system of claim 8, wherein said sub-tables are manipulatable within said workspace by a user, so that the user changes the spatial placement of said first and/or second sub-tables to create a desired composite table.

10. The system of claim 8 wherein a composite query comprising simple sub-queries with set operations is displayed as a nested table arranged within the created composite table.

11. The system of claim 8 wherein a composite query comprising simple sub-queries with join operations is displayed as a nested table arranged within the composite table.

12. The system of claim 8 wherein a placement of said second sub-table immediately below said first sub-table generates said composite table as a concatenated table with said first and second sub-tables connected by a default set operator.

13. The system of claim 8 wherein a placement of a said second sub-table immediately next to said first sub-table generates said composite table as a joined table.

14. The system of claim 8 wherein the relationship of said first and second sub-tables within said composite table may be modified by changing properties of table connectors connecting said first and second sub-tables.

15. A computer program product for constructing composite queries using two-dimensional sub-tables displayed in a workspace of a graphical user interface, where each sub-table represents a simple query against a predefined data source, the computer program product comprising a computer-readable storage medium having computer-readable program code embodied in the medium, the computer-readable program code comprising:
computer-readable program code that defines a plurality of algebraic relationships between data in a first sub-table displayed in said workspace and data in a second sub-table displayed on said workspace based on a spatial placement of said first sub-table relative to said second sub-table;
computer-readable program code that identifies the spatial placement of said first sub-table and said second sub-table in said workspace; and
computer-readable program code that creates a composite table comprising said first sub-table and said second sub-table when the spatial placement of said first sub-table relative to said second corresponds to one of said defined plurality of algebraic relationships.
